(19) United States
(12) Patent Application Publication
(10) Pub. No.: US 2004/0132903 A1
(43) Pub. Date: Jul. 8, 2004

(54) Polyurethane composition with glass cullet catalyst and method of making same

(76) Inventor: Van I. Doesburg, Dalton, GA (US)

Correspondence Address: JOHN S. PRATT, ESQ, KILPATRICK STOCKTON, LLP, 1100 PEACHTREE STREET, SUITE 2800, ATLANTA, GA, 30309, US

(21) Appl. No.: 10/338,796

(22) Filed: Jan. 7, 2003

(51) Int. Cl. C08G 18/00

(52) U.S. Cl. 524/871

(57) ABSTRACT

There is disclosed a polyurethane composition with glass cullet as a polyurethane-forming catalyst. The composition comprises at least one polyol, an isocyanate, and glass cullet. The glass cullet has an average particle size of less than 100 mesh. The composition is free or substantially free of other catalysts or catalyst systems for forming polyurethane. A method of producing a polyurethane composition with a glass cullet polyurethane-forming catalyst is also disclosed.

### FIELD OF INVENTION

The present invention relates generally to polyurethane compositions, and, more specifically, to polyurethane compositions containing glass cutlet as a catalyst. A method of making polyurethane compositions using glass cullet as a catalyst is also disclosed.

### BACKGROUND OF THE INVENTION

Polyurethane compositions are well known in the art. Polyurethane compositions can be solid or cellular, flexible or rigid. Solid polyurethane compositions are used for many applications, such as insulative structural members and textile coatings, such as carpet backing coatings to adhere tufts of yarn to primary backing materials or to adhere secondary backing materials to primary backing materials. Cellular polyurethane, such as foamed or frothed polyurethane, is used for items such as cushions and textile coatings, such as integrally attached cushions for carpet.

With all types of polyurethane compositions fillers can be used to reduce the cost per unit volume of the polyurethane compositions. Fillers that have been known for use in polyurethane compositions include, clays, wood flour, cork dust, cotton flock, marble dust, shredded or finely powdered cornsilks, finely ground nut shells, fly ash and the like.

Recently, there has been a move to include recycled products as a portion of new products. U.S. Pat. Nos. 6,313,207; 6,310,114; 6,306,976; and 6,284,186 disclose the use of various types of glass with different plastic compositions. However, to date, efforts to incorporate glass cullet with polyurethane compositions have not been entirely satisfactory. In previous polyurethane compositions, the glass cullet was used only as a filler, and conventional catalyst systems were also used. Heretofore, it was not know that glass cullet could be used to catalyze a polyurethane-forming reaction in the absence of conventional catalyst systems. Therefore, a recycled product that could be used as both a filler and a catalyst for polyurethane would be desirable.

### SUMMARY OF THE INVENTION

The present invention satisfies the above-described needs by providing an improved polyurethane composition including recycled glass cullet in the absence of conventional polyurethane catalyst systems. The improved polyurethane compositions of the present invention comprise at least one polyol; an isocyanate; and glass cullet. The glass cullet has an average particle size of less than 100 mesh. The composition is also substantially free of other catalysts for forming polyurethane.

In an alternate embodiment, the present invention comprises a polyurethane composition that comprises polyurethane-forming components and glass cullet having an average particle size such that the composition is catalyzed by the glass cullet, the composition being substantially free of conventional catalyst systems for forming polyurethane.

The present invention also comprises a method of forming a polyurethane composition. The method comprises the step of combining at least one polyol, an isocyanate, and glass cullet having an average particle size of less than 100 mesh, the composition being substantially free of conventional catalyst systems for forming polyurethane.

In an alternate embodiment, the present invention comprises a method of forming a polyurethane composition. The method comprises combining with polyurethane-forming components glass cullet having an average particle size such that said composition is catalyzed by the glass cullet, the composition being substantially free of conventional catalyst systems for forming polyurethane.

Accordingly, it is an object of the present invention to provide an improved polyurethane composition and an improved method for forming a polyurethane composition.

Another object of the present invention is to provide an improved filled polyurethane composition and a method of forming a filled polyurethane composition.

A further object of the present invention is to provide a filled polyurethane composition that includes a recycled product.

Yet another object of the present invention is to provide a filled polyurethane composition that includes glass cullet as a filler.

Another object of the present invention is to provide a catalyst for forming polyurethane.

Still another object of the present invention is to provide a polyurethane composition that includes glass cullet as a catalyst.

These and other objects, features and advantages of the present invention will become apparent after a review of the following detailed description of the disclosed embodiments and the appended claims.

### DETAILED DESCRIPTION OF THE DISCLOSED EMBODIMENTS

The present invention relates to polyurethane compositions including glass cullet as a catalyst for forming polyurethane. Such polyurethane compositions are free from conventional catalyst systems for forming polyurethane. Glass cullet is therefore the only catalyst used to catalyze the polyurethane forming reaction.

Glass cullet is glass that is broken or ground into relatively smaller pieces. Generally speaking, glass cullet is made by grinding recycled glass into a desired particle size. Glass cullet can range in particle size from approximately ⅝ inch to very fine powders, such as minus 325 mesh. Glass powders have been known to be useful as fillers for paint, stucco and plastic products.

Glass cullet is typically made from post-consumer glass; i.e., recycled glass from consumer applications. There are essentially six sources for post-consumer glass cullet: plate glass (also know as soda lime glass), E. glass, borosilicate glass, flint glass (also known as bottle glass), amber glass (also known as bottle glass), emerald glass (also known as bottle glass). Each of the foregoing different types of glass has different chemical compositions. The approximate chemical composition of each of the foregoing types of glass is shown in Tables I-VI below.

TABLE I
Plate Glass (Soda Lime)

| Chemical | % by Weight |
|---|---|
| SiO | 73.25 |
| Na₂O | 13.46 |
| CaO | 8.58 |
| MgO | 3.77 |
| Fe₂O₃ | 0.356 |
| A1₂O₃ | 0.28 |
| SO₂ | 0.19 |
| K₂O | 0.011 |
| PbO | 0.0037 |
| Cr₂O₃ | 0.0023 |

Plate glass has a softening point of approximately 724° C. or 1335° F.

TABLE II
E. Glass

| Chemical | % by Weight |
|---|---|
| SiO | 54.39 |
| CaO | 18.1 |
| Al₂O₃ | 14.2 |
| B₂O₃ | 6.73 |
| MgO | 4.51 |
| MgO | 1.04 |
| Na₂O | 0.57 |
| TiO₂ | 0.36 |
| K₂O | 0.10 |

E. glass has a softening point of approximately 852° C. or 1565° F.

TABLE III
Borosilicate Glass

| Chemical | % by Weight |
|---|---|
| SiO | 80.58 |
| B₂O₃ | 12.4 |
| Na₂O | 4.13 |
| Al₂O₃ | 2.26 |
| Fe₂O₃ | 0.38 |
| CaO | 0.11 |
| K₂O | 0.06 |
| Cl | 0.051 |
| ZrO₂ | 0.034 |

Borosilicate glass has a softening point of approximately 819° C. or 1506° F.

TABLE IV
Flint Glass (Bottle Glass)

| Chemical | % by Weight |
|---|---|
| SiO | 73.21 |
| Na₂O | 13.45 |
| CaO | 10.32 |
| Al₂O₃ | 1.34 |
| MgO | 1.04 |
| K₂O | 0.40 |
| SO₂ | 0.16 |
| Fe₂O₃ | 0.081 |
| Cr₂O₃ | 0.0026 |

Flint glass has a softening point of approximately 732° C. or 1349° F.

TABLE V
Amber Glass (Bottle Glass)

| Chemical | % by Weight |
|---|---|
| SiO | 72.45 |
| Na₂O | 13.01 |
| CaO | 10.48 |
| Al₂O₃ | 1.95 |
| MgO | 0.68 |
| K₂O | 0.44 |
| Fe₂O₃ | 0.31 |
| SO₂ | 0.08 |

Amber glass has a softening point of approximately 728° C. or 1342° F.

TABLE VI
Emerald Green Glass (Bottle Glass)

| Chemical | % by Weight |
|---|---|
| SiO | 72.26 |
| Na₂O | 13.11 |
| CaO | 10.47 |
| Al₂O₃ | 2.05 |
| K₂O | 0.93 |
| MgO | 0.78 |
| Fe₂O₃ | 0.205 |
| Cr₂O₃ | 0.12 |
| SO₂ | 0.08 |

Emerald green glass has a softening point of approximately 730° C. or 1346° F.

Glass cullet as a catalyst/filler for polyurethane compositions has several advantages over other types of catalyst or filler systems. Glass cullet is odorless and non-toxic. Glass cullet is readily available from commercial sources. Glass cullet can be ground into desired particle sizes and individual glass types; i.e., flint, plat, E. glass, etc., are relatively easily separated from recycled glass sources. Glass cullet is also generally less expensive than conventional catalysts for polyurethane. Glass cullet useful in the present invention is commercially available from Strategic Materials, Inc., Houston, Tex.; TriVitro, Kent, Wash.; and Universal Ground Cullet, Brook Park, Ohio.

Polyurethane compositions are well known to those skilled in the art. Polyurethane compositions in accordance with the present invention may be solid or cellular, i.e., foamed or frothed, rigid or flexible. The particular composition of the polyurethane-forming components is not a critical aspect of the present invention. However, the polyurethane compositions of the present invention are desirable free, or substantially free, from other catalysts or catalyst systems for forming polyurethane. The term substantially free from other catalysts or catalyst systems as used herein means that the polyurethane-forming components do not include sufficient quantities and/or types of compounds to cure the polyurethane within 5 minutes, preferably within 60 seconds, in the absence of the glass cullet catalyst of the present invention. The term polyurethane-forming as used herein means the chemical components that form polyurethane, excluding the catalyst. The term cure as used herein means that the composition is solid, as opposed to liquid, when applied to non-cellular compositions, and means that the foam has some resiliency, when applied to cellular compositions. It will be understood by those skilled in the art that if heat is used to accelerate the curing process, the curing times mentioned above will be shorter depending on the amount of heat applied.

All polyurethane compositions will cure in the absence of a catalyst. A catalyst merely functions to accelerate the rate of the polyurethane-forming reaction. The use of catalysts is generally necessary because in their absence the polyurethane-forming reaction rate usually is too slow to be commercially useful. More importantly, when forming blown foams or mechanically frothed foams, the reaction rate is critical. For foams, if the reaction rate is too slow, the foam structure may collapse, or partially collapse, before the polyurethane has cured sufficiently to provide sufficient strength to maintain the foam structure. Therefore, when dealing with polyurethane foams, the term substantially free from other catalysts or catalyst systems as used herein means that the polyurethane-forming components do not include sufficient quantities and/or types of compounds to cure the polyurethane before the foam structure collapses, or partially collapses, in the absence of the glass cullet catalyst of the present invention. The term partially collapses as used herein means that the foam structure has collapse approximately 15% or more; preferably approximately 10% or more. Thus, it will be appreciated that when using the glass cullet catalyst of the present invention even if additional catalysts or catalyst systems are necessary the glass cullet catalyst permits the use of reduced amounts of those additional catalysts or catalyst systems than would otherwise be needed.

Polyurethane is a polymerization product of a polyol component, an isocyanate component, water (optional) and a catalyst system that promotes a polymerization reaction between the isocyanate component and the polyol component to form the polyurethane. Conventional practice in the art is to form an isocyanate mixture, referred to as SIDE A; and to form a mixture of polyols, chain extenders, cross-linking agents, fillers, blowing agents, surfactants, catalysts etc., commonly referred to as SIDE B. The SIDE A component and the SIDE B component are mixed together at a desired ratio to form the polyurethane polymer. See U.S. Pat. No. 5,159,012 the disclosure of which is incorporated herein by reference.

The polyol component may contain either a single polyol or a mixture of two or more polyols. The specific polyols useful in the manufacture of polyurethane elastomers are well known in the art and include aliphatic, alicyclic and aromatic polyols. More specifically, the polyol component useful in this invention has an average functionality within the range of 2-8, preferably within the range of 2-3, and an average molecular weight of from about 900 to about 9000, preferably from about 1000 to about 6000. The polyol component may contain isomeric and polymeric polyols. Additionally, the polyol component has a hydroxyl number of less than about 160, preferably less than about 137.

The preferred polyols suitable for use in present invention include, but are not limited to, ethylene glycol; diethylene glycol; propylene glycol; dipropylene glycol; glycerine; sucrose; butylene glycol; polyether polyols derived from ethylene oxide, propylene oxide, and mixtures of such oxides; polyether polyols derived from propylene oxide and capped with ethylene oxide; polyethylene glycol; polypropylene glycol; polybutylene glycol; 1,2-polydimethylene glycol; polydecamethylene glycol and mixtures of the above polyols.

The polyurethane composition can be either foamed or unfoamed. In those instances where foaming is desired, such can be accomplished by using an inert gas frothing technique, a volatile liquid blowing agent technique, a chemically blown (water) technique or combinations thereof, in conjunction with a surface active agent, such as the commercially available block polysiloxane-polyoxyalkylene copolymers.

Chemical blowing of the polyurethane composition, if desired, is effected by controlling the catalyst system, the water concentration and the isocyanate level. Generally, water is present in the reaction mixture from between approximately 0.01 to 5.0 parts per hundred parts of polyol, preferably between 0.1 parts and 2 parts, over and above the water normally present in the reaction mixture. The catalyst system not only must effect rapid curing but also must control formation of carbon dioxide resulting from the reaction of water and isocyanate. Blowing should be controlled to effect expansion between about 5% and 200%, preferably between approximately 7% and 100%, so that a carpet yarn loop back stitch is saturated with reactants and the reactants expand sufficiently prior to curing.

For chemically blown polyurethane, it is desirable to use one or more additional catalysts in addition to the glass cullet catalyst in order to promote chemical blowing. However, as stated above, it is desirable to select the additional catalyst(s) and use an amount of such additional catalyst(s) such that the polyurethane composition would not cure within 5 minutes, preferably 60 seconds, and/or the foam structure would partially collapse in the absence of the glass cullet catalyst. Suitable catalysts for use in chemically blown polyurethanes in combination with the glass cullet catalyst include, but are not limited to, triethylamine, dibutyl tin dilaurate and triethylenediamine. Amounts of such additional catalysts when used in combination with the glass cullet catalyst are generally less than 0.32 percent by weight; preferably, approximately 0.20 to 0.02 percent by weight.

The isocyanate component may contain either a single isocyanate or a mixture of two or more isocyanates. The specific isocyanates useful in the manufacture of polyurethane polymers are well known in the art and include aliphatic, alicyclic and aromatic isocyanates. Preferred isocyanates have an average functionality within the range of 2-8, preferably within the range of 2-5. Examples of preferred isocyanates are 2,4-toluene diisocyanate; 2,6-toluene diisocyanate; 1,6-hexamethylene diisocyanate; naphthalene-1,4-diisocyanate; diphenyl methane 4,4′-diisocyanate; 4,4′-diphenylene diisocyanate; 3,3′-dimethoxy biphenylene diisocyanate; polymeric forms of the above diisocyanates, diisocyanato carbodiimide modified diphenylmethane 4,4′-diisocyanate (MDI), isocyanate terminated prepolymers, and mixtures of the foregoing. The isocyanate component (Side A) usually is employed in stoichiometric excess to assure complete reaction with the functional groups of the polyol and with any water that may be present. Preferably, from 20 to 80 parts isocyanate per one hundred parts of polyol are used in the reaction mixture.

A general polyurethane formulation that is useful in the present invention is shown in Table VII below:

TABLE VII

| Ingredient | Parts |
|---|---|
| Polyol | 100 |
| Surfactant (silicon glycol | 0-2 |
| copolymer) | |
| Water | 0-2 |
| Other filler | 0-400 |
| Additives | 0-50 |
| Glass cullet catalyst/filler | 5-150 |
| Other catalysts | 0-3 |
| Isocyanate | sufficient |
| | (index |
| | 70-130) |

In order to prepare a polyurethane formulation using a glass cullet catalyst, glass cullet is added to the polyurethane-forming components. The glass cullet can be added to the B side component in amounts between approximately 5% and 95% by weight. The polyurethane compositions of the present invention can be used to make polyurethane foams having densities of from approximately 7 to 80 pounds per cubic foot.

Types of glass cullet that are useful in the present invention include plate glass, soda lime glass, E. glass, borosilicate glass, flint glass, amber glass and emerald glass. However, particularly preferred sources of glass cullet for use in the present invention are bottle glass; i.e., flint glass, amber glass, and emerald green glass. An especially preferred source of glass cullet for use in the present invention is tri-color glass that is a mixture of equal amounts of flint glass, amber glass, and emerald green glass.

Irrespective of the source of the glass cullet, the glass cullet useful in the present invention desirably has a pH in deionized water of not greater than 8.4. Preferably, the glass cullet useful in the present invention should have a pH in deionized water of about 7 to 8.4. Glass cullet from e. glass, borosilicate glass, flint glass, amber glass and emerald glass satisfies this condition.

It has also been discovered as a part of the present invention that the average size of the particles of the glass cullet has an effect on several different aspects of the polyurethane composition. In determining the particle size of the glass cullet useful in the present invention, three factors must be balanced: reaction rate, viscosity and stability. Generally speaking, the smaller the particle size of the glass cullet, the greater the catalytic effect of the glass cullet, and, therefore, the faster the polyurethane forming reaction will occur. On the other hand, the smaller the glass cullet particle size, the higher the viscosity of the Side B composition. Furthermore, the smaller the particle size, the more stable the polyurethane composition; i.e., the glass cullet will remain in suspension in the Side B composition.

The glass cullet useful in the present invention desirably has an average particle size such that the Side B composition has a viscosity of approximately 1,000 to 13,000 cps at 25° C. Stated another way, the glass cullet useful in the present invention should have an average particle size such that it catalyzes the formation of polyurethane. Preferably, the glass cullet useful in the present invention should have an average particle size less than 100 mesh (149 microns); more preferably approximately 100 mesh to 325 mesh (44 microns). Most preferably, the glass cullet useful in the present invention should have an average particle size of approximately 100 mesh to 270 mesh.

The following examples are illustrative of the present invention and are not intended to limit the scope of the invention as set forth in the appended claims. All temperatures are in degrees Fahrenheit and all percentages are by weight unless specifically stated otherwise.

### EXAMPLE 1

Polyurethane compositions were prepared according to the formulas shown in Table VIII below:

TABLE VIII

| | Formula | Formula | Formula |
|---|---|---|---|
| Ingredient | A | B | C |
| Voranol 4701 | 90 | 90 | 90 |
| Diethylene glycol | 10 | 10 | 10 |
| Molecular sieve | 3 | 3 | 3 |
| Calcium Carbonate | 100 | 50 | 0 |
| Three-color glass cullet (−100 | 0 | 50 | 100 |
| mesh) | | | |
| L-5614 | 2.0 | 2.0 | 2.0 |
| Isocyanate 7710 | 39.43 | 39.43 | 39.43 |

In the foregoing formulas, Voranol 4701 is a polyether polyol with ethylene end cap available from Dow Chemical Company, Midland, Mich.; the molecular sieve is a ceramic zeolites resin that absorbs water available from Zeochem of Louisville, Ky. under the trade name Purmol Powder; L-5614 is a silicone surfactant available from OSI Specialties of South Charleston, West Va.; and 7710 is a modified MDI available from Dow Chemical Company.

Three separate mechanically frothed formulations were prepared according to the foregoing formulas. The three different formulations were prepared with glass cullet from three-color glass; i.e., a mixture of equal amounts of flint, amber and emerald green glass.

In order to be commercially useful, the polyurethane formulations in accordance with the present invention should have a reactivity of greater than 5 minutes at 75° F., should have a cure time of less than 130 seconds (for a polyurethane film approximately 1/16 inch thick placed on a 250° F. hot plate) and should be stable for at least 14 days. The properties of each of the three formulations is shown in Table IX below:

TABLE IX

| Property | Formula A | | Formula B | | Formula C | |
|---|---|---|---|---|---|---|
| Cure | >5 | minutes | 110 | sec. | 23 | sec. |
| Reactivity: | @ 30 | min. | 13 min. 18 sec. | | 1 min. 11 sec. | |
| Viscosity* | 4,200 | cps | 50,000 | cps | 50,000 | cps |
| Temperature | 109.8° | F. | 148.4° | F. | 151.1° | F. |

*The viscosity is measured at the reported reactivity time.

At 5 minutes, Formula A still had not cured; whereas, Formula B cured in less than 2 minutes and Formula C cured in slightly more than 1 minute. The temperature of Formulas B and C also rose significantly faster than Formula A. The foregoing samples were performed with the polyurethane compositions sitting in a cup at room temperature.

The viscosity of the Side B polyol of Formula A was 13,750 cps at 75.4° F.; Formula B was 8,500 cps at 75.4° F.; and Formula C was 7,900 cps at 75.2° F. Generally, the polyurethane compositions of the present invention should have a viscosity of less than 18,000 cps at 25° C.; preferably less than 13,000 cps at 25° C.; and especially approximately 3,000 to 10,000 cps at 25° C.

### EXAMPLE 2

Polyurethane compositions were prepared according to the formulas shown in Table X below:

TABLE X

| | Formula | Formula | Formula |
|---|---|---|---|
| Ingredient | D | E | F |
| Voranol 4701 | 90 | 90 | 90 |
| Diethylene glycol | 10 | 10 | 10 |
| Molecular sieve | 3.0 | 3.0 | 3.0 |
| Calcium Carbonate | 100 | 50 | 0 |
| Three-color glass cullet | 0 | 50 | 100 |
| (−100 mesh) | | | |
| L-5614 | 2.0 | 2.0 | 2.0 |
| Isonate 94 | 33.98 | 33.98 | 33.98 |

Isonate 94 is a polymeric MDI by Dow Chemical Corporation.

The properties of each of the three formulations are shown in Table XI below.

TABLE XI

| Property | Formula D | | Formula E | | Formula F | |
|---|---|---|---|---|---|---|
| Cure | >5 | minutes | 140 | sec. | 33 | sec. |
| Reactivity: | @ 30 min. | | 20 min. 54 sec. | | 1 min. 11 sec. | |
| Viscosity* | 4,900 | cps | 50,000 | cps | 50,000 | cps |
| Temperature | 99.1° | F. | 128.8° | F. | 117.2° | F. |

*The viscosity is measured at the reported reactivity time.

At 5 minutes, Formula D still had not cured; whereas, Formula E cured in slightly more than 2 minutes and Formula F cured in less than 1 minute. The temperature of Formulas E and F also rose significantly faster than Formula D.

The viscosity of the polyol (B Side) of Formula D was 10,150 cps at 75.4° F.; Formula E was 5,400 cps at 75.6° F.; and Formula F was 5,800 cps at 75.2° F.

### EXAMPLE 3

Polyurethane compositions are prepared according to the formulas shown in Table XII below:

TABLE XII

| | Formula |
|---|---|
| Ingredient | G |
| Voranol 4701 | 78.5 |
| Pluracol 1442 | 20.0 |
| Ethylene glycol | 1.5 |
| Water | 1.5 |
| Three-color glass cullet (−100 | 15-20 |
| mesh) | |
| Triethylamine | 0.15 |
| Dibutyl tin dilaurate | 0.15 |
| Isocyanate blend (50/50 papi | 37.8 |
| 94, papi 27) | |

The foregoing formula produces a chemically blowable polyurethane foam.

### EXAMPLE 4

Polyurethane compositions are prepared according to the formulas shown in Table XIII below:

TABLE XIII

| | Formula |
|---|---|
| Ingredient | H |
| Voranol 4701 | 78.5 |
| Pluracol 1442 | 20.0 |
| Ethylene glycol | 1.5 |
| Silicone surfactant L5614 | 2.0 |
| Three-color glass cullet (−100 | 15-20 |
| mesh) | |
| Isocyanate blend (50/50 papi | 37.8 |
| 94, papi 27) | |

The foregoing formula produces a mechanically frothable polyurethane foam.

It should be understood, of course, that the foregoing relates only to certain disclosed embodiments of the present invention and that numerous modifications or alterations may be made therein without departing from the spirit and scope of the invention as set forth in the appended claims.

What is claimed is:

1. A composition comprising at least one polyol, an isocyanate, and glass cullet, said glass cullet having an average particle size of less than 100 mesh and said composition being substantially free of another catalyst or catalyst system for forming polyurethane.

2. The composition of claim 1, wherein said glass cullet has an average particle size of approximately 100 to 325 mesh.

5. The composition of claim 1, wherein said glass cullet comprises approximately 5 to 95 weight percent of said composition.

6. The composition of claim 1, wherein said composition has a density after curing of approximately 7 to 80 pounds per cubic foot

7. The composition of claim 1, wherein said glass cullet is derived from bottle glass.

8. The composition of claim 1, wherein said glass cullet is derived from flint glass, amber glass, emerald green glass, borosilicate glass, E. glass or combinations thereof.

9. The composition of claim 1, wherein said glass cullet is derived from tri-color glass.

10. The composition of claim 1, wherein said glass cullet is recycled glass.

11. A composition comprising at least one polyol, an isocyanate, and glass cullet, said glass cullet having an average particle size such that polyurethane formation is catalyzed by the glass cullet, said composition being substantially free of other catalysts or catalyst systems for forming polyurethane.

12. A method comprising the steps of adding to a composition comprising at least one polyol and an isocyanate an amount of glass cullet sufficient to catalyze the formation of polyurethane, said glass cullet having an average particle size of less than 100 mesh.

13. The method of claim 12, wherein said glass cullet has an average particle size of approximately 100 to 325 mesh.

16. The method of claim 12, wherein said glass cullet comprises approximately 5 to 95 weight percent of said composition.

17. The method of claim 12, wherein said composition has a density after curing of approximately 7 to 80 pounds per cubic foot

18. The method of claim 12, wherein said glass cullet is derived from post-consumer bottle glass.

19. The method of claim 12, wherein said glass cullet is derived from flint glass, amber glass, emerald green glass, borosilicate glass, E. glass or combinations thereof.

20. The method of claim 12, wherein said glass cullet is derived from tri-color glass.

21. The method of claim 12, wherein said glass cullet is recycled glass.

22. A filled polyurethane composition comprising:
polyurethane-forming components; and
glass cullet as a polyurethane-forming catalyst and as a filler, said glass cullet having an average particle size less than 100 mesh, and said composition being substantially free of other catalysts or catalyst systems for forming polyurethane.

23. A filled polyurethane composition comprising:
polyurethane-forming components; and
glass cullet, said glass cullet being of a type and having an average particle size such that said polyurethane composition has a reactivity of greater than 5 minutes.

24. A filled polyurethane composition comprising:
polyurethane-forming components; and
glass cullet as a polyurethane-forming catalyst and as a filler, said glass cullet being of a type and having an average particle size such that said polyurethane composition has a cure time of less than 130 seconds, and said composition being substantially free of other catalysts or catalyst systems for forming polyurethane.

25. A filled polyurethane composition comprising:
polyurethane-forming components; and
glass cullet as a polyurethane-forming catalyst and as a filler, said glass cullet being of a type and having an average particle size such that said polyurethane composition has a viscosity of less than 13,000 cps at 25° C. and a stability of at least 14 days, and said composition being substantially free of other catalysts or catalyst systems for forming polyurethane.

26. An article made from the composition of claim 1.

27. A polyurethane polymer comprising:
a Side B composition comprising at least one polyol and glass cullet as a catalyst, said glass cullet having an average particle size of less than 100; and
a Side A composition comprising at least one isocyanate at an index between 80 and 120.

28. A Side B composition comprising at least one polyol and glass cullet as a polyurethane-forming catalyst, said glass cullet having an average particle size such that said composition has a viscosity of less than approximately 13,000 cps at 25° C. and is stable for at least 14 days, and said composition being substantially free of other catalysts or catalyst systems for forming polyurethane.

29. A filled Side B polyurethane composition comprising polyurethane-forming components and glass cullet as a polyurethane-forming catalyst and as a filler, said glass cullet being of a type and having an average particle size such that said polyurethane composition has a viscosity of less than 13,000 cps at 25° C. and a stability of at least 14 days, and said composition being substantially free of other catalysts or catalyst systems for forming polyurethane.

30. An article made from the composition of claim 27.

31. A method comprising the steps of:
forming a mixture of at least one polyol, an isocyanate, and glass cullet, said glass cullet having an average particle size of less than 100 mesh and said composition being substantially free of another catalyst or catalyst system for forming polyurethane; and
curing said mixture to form a polyurethane composition.

32. The method of claim 31 further comprising the step of forming said mixture into a foam before it is cured.
